(19) United States
(12) Patent Application Publication
(10) Pub. No.: US 2021/0188473 A1
(43) Pub. Date: Jun. 24, 2021

(54) Pre-Filled and Pre-Sealed Beverage Container Sleeve Applicator

(71) Applicant: ELIQS LLC, Gardena, CA (US)

(72) Inventors: Joseph Patrick Schwappach, Marina Del Rey, CA (US); David Moore Goldman, Santa Monica, CA (US); Max Joseph Berg, Los Angeles, CA (US)

(21) Appl. No.: 17/127,892

(22) Filed: Dec. 18, 2020

Related U.S. Application Data
(60) Provisional application No. 62/950,582, filed on Dec. 19, 2019.

(51) Int. Cl. B65C 3/06; B65C 9/04; B65C 9/06; B65C 9/40; B65B 53/06

(52) U.S. Cl. CPC B65C 3/065; B65C 9/04; B65B 53/06; B65C 9/40; B65C 9/06

(57) ABSTRACT

A system for labeling a beverage container includes a conveyer structured to receive and transport the beverage container. The beverage container is prefilled with an ingestible content and sealed. The top of the beverage container has a mark that a lid reader uses to determine a orientation position and generate an alignment signal. Can positioning pads use the alignment signal to position the beverage container rotationally until the mark aligns with a reference position. An air blast station may be present to release high pressure air onto an exterior of the beverage container and a sleeve applicator overlay a shrink wrap sleeve around an exterior of the beverage container. A steam tunnel uses steam to cause the shrink wrap sleeve label to shrink onto the beverage container.

### CROSS REFERENCE TO RELATED APPLICATIONS

This application claims the benefit of U.S. Provisional Application No. 62/950,582, filed Dec. 19, 2019, which is incorporated by reference in its entirety.

### TECHNICAL FIELD

The disclosure relates to a manufacturing system for labeling of pre-filled and pre-sealed beverage containers.

### BACKGROUND

The existing production process for custom-branded or private label canned beverages requires large minimum order sizes, long lead times, and non-uniform label placement. Existing canning and labeling processes require that labeled cans are created prior to being filled with a beverage. This requires advanced coordination to have containers manufactured with appropriate labeling and thereafter forwarded for filling and sealing. This process can be expensive and time consuming from a manufacturing production perspective as each new beverage label must first have the can labeled and then forwarded for fill and seal.

Labeling after beverage cans are filled and sealed result in quality control issues. For example, labeling on filled and sealed containers forms air pockets between the container and label resulting in a low-quality look for a completed product. Further, uniformity of labeling becomes more difficult to achieve as filled and sealed containers become more difficult to align, e.g., tab openings on top of container are appropriately aligned relative to label placement.

Hence, there is lacking a manufacturing system that provides high quality, uniform labeling for already filled and sealed beverage containers, that allows for micro-batch can customization with short lead times measured, e.g., a day to few days.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 illustrates a multi-step manufacturing production system for application of a customized label on a beverage container.

FIG. 2A illustrates one embodiment of tops of beverage containers with a tab located in a different location for each beverage container.

FIG. 2B illustrates one embodiment of tops beverage containers aligned in a same (e.g., reference) direction.

FIG. 3 illustrates a manufacturing process for uniform application of labels to a pre-filled and pre-sealed beverage container.

FIG. 4. illustrates example components of processing machine that may be used to operate the control systems for the manufacturing process.

FIG. 5 illustrates an example output from a manufacturing production system that applies a customized label onto beverage containers.

### DETAILED DESCRIPTION

Disclosed is a system that allows for labeling cans pre-filled with beverages (or other ingestible content and presealed. The system provides for uniformity of label location and micro-batch customization with no lead time.

### Example Assembly System

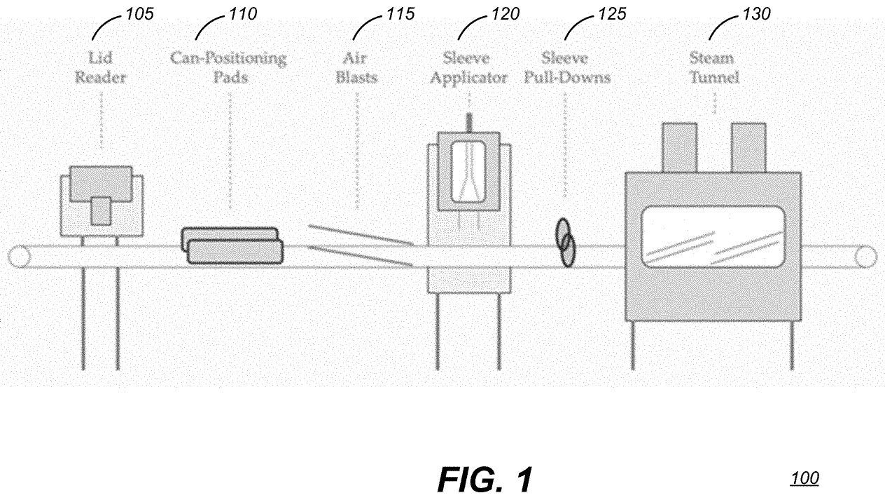

FIG. 1 illustrates a multi-step manufacturing production system 100 for application of a customized label on a beverage container. The manufacturing production system 100 is configured to apply a label at a uniform location on a beverage container. In one example embodiment the beverage container is an aluminum beverage can with an openable top (e.g., push tab or pull tab mouth opening on a top (or cap) of a can). Unlike nearly all other beverage providers, the disclosed manufacturing production system 100 applies labels to cans that are pre-filled with a beverage (e.g., already filled with a beverage or other liquid content) and properly sealed with a beverage container lid. Hence, the cans are filled and fully sealed. They may be sealed with a beverage or other ingestible content. Conventionally, such cans are labeled prior to fill and seal in order to enable quality labeling that otherwise would not be possible due to issues such as condensation on the can surface and alignment of the can for uniformity. Unlike such conventional systems the manufacturing production system 100 disclosed herein allows for custom labeling after the beverage containers have been filled and sealed, while maintaining quality control of conventional manufacturing processes.

The manufacturing production system 100 in FIG. 1 includes a number of stations (or machine subsystems or components). The stations include a lid reader 105, one or more can positioning pads 110, one or more air blast stations (e.g., jet air blower and/or fans) 115, a sleeve applicator 120, a sleeve pull down station 125 (e.g., clamps (to grip the sleeve and place into position) or motorized rubber ribbons (to apply a repeated positional force (e.g., repeated friction against the sleeve downward) to place the sleeve into position)), and a steam tunnel 130. Each of the stations of the manufacturing production system 100 may be interoperably coupled as a manufacturing assembly in which the beverage container may move station to station in an automated manner. Further, the air blast station 115 and sleeve pull down station may be optional. Each station is further described below.

### Lid Reader

To control the position of each design on every beverage container, and thereby ensuring uniformity, each beverage container must be uniformly oriented prior to sleeve application. The lid reader 105 is a station that includes an optical or image detector to determine the initial orientation of each beverage container after it is loaded onto the conveyor. The lid reader determines this orientation by registering the positioning of a tab (e.g., where a beverage container may be opened) on the top of each beverage container. The beverage containers are loaded vertically (upright) although they may be loaded horizontally and the lid reader 105 may be positioned accordingly to get an optical or image read of the beverage container top.

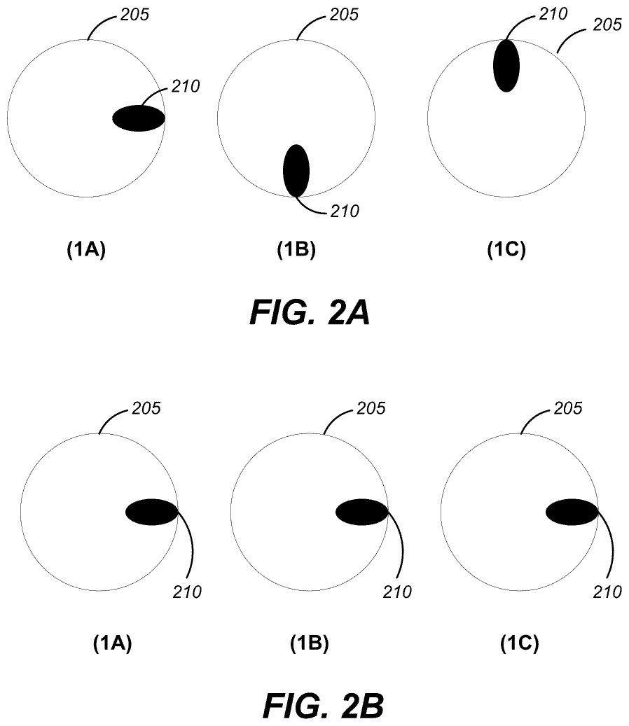

FIG. 2A illustrates a top of three beverage containers (1A, 1B, 1C) 205 with a tab 210 on each in different directions relative to each other. The tab 210 may be a mark corresponding to the current position and may use an alignment signal (or positional indication signal) that may be used to compare against a reference mark to which the scanned tab 210 may subsequently align to. The reference frame may be an image to which an image of the current beverage container tab 210 can align to visually or may be coordinate based, for example, relative direction to which the tab 210 may need to move on an angular direction to align to that direction. The orientation data corresponding to the position of the tab at the top of each beverage container is captured by the lid reader 105 and transmitted to the can positioning pads 110 station.

### Can Positioning Pads

The orientation data may be the alignment signal from the lid reader 105. It is received by a control system coupled with the can-positioning pads 110 station. The can positioning pads 110 may be structured as one or more padded rollers or vibration pads. The surface of the can positioning pads 110 may be comprised of a rubber, foam or other pliable material that protects against physical damage to the can (e.g., dents). The can positioning pads 110 have their surface oriented along the length of the beverage container. For example, if the beverage container arrives oriented in a vertical direction (top facing upward), the can positioning pads 110 also may be oriented vertically.

The can positioning pads 110 are structured to position the beverage container in a uniform direction. For example, a control system associated with the can positioning system 110 may include a reference frame correlating to a specific direction (or location) for a tab that each beverage container top should align to. That is, all beverage containers coming through should leave the can positioning pads 110 with the tabs facing the same direction. For example, FIG. 2B illustrates that the reference frame should have each beverage container (1A through 1C) leave the can positioning pads 110 with the top 205 of the beverage containers having their tabs 210 all facing to the right.

The control system receives alignment signal from the lid reader 110 for a beverage container and compares it to the reference frame direction. The control system may calculate a positional difference between the orientation data of the can moving through to the reference frame direction. The difference is transmitted as a signal to the rollers on the can positioning pads 110, which are communicatively coupled with the control system. The rollers receive the signal from the control system to rotate the rollers at a speed and angular rotation such that the tab on the can is aligned (or positioned) in the same direction as the reference frame direction. The speed and angular rotation may occur at differing rates within a cycle of operation on the beverage container. For example, with reference to FIGS. 2A and 2B, the can positioning pads 110 would take no action on beverage container 1A as its top 205 and tab 210 in FIG. 2B is already aligned with the reference frame. For beverage containers 1B and 1C, the can positioning pads 110 would be configured to rotate each beverage containers 1B, 1C until their respective tops 205 had their respective tabs 210 align with the reference frame (and the first beverage container 1A top 205 and tab 210).

The can-positioning pads 110 may include other configurations. For example, they may be small vertical conveyors with slightly more flexible surfaces (walls) than the standard conveyor carrying cans through the system. The conveyors may work in tandem to adjust the orientation of each can by rotating the can through varying levels of movement by the conveyors.

The can positioning pads 110 may be further configured to have the control system use the orientation data to control the pad movement until the alignment of the beverage container is completed, at which time the control system transmits a signal to stop the pad movement against the beverage container. In one example embodiment, the pads may be one or more rollers and the control system may adjust a rotational speed of the rollers to achieve alignment of the beverage container. In another example embodiment the pads may be pliable pads that may be actuated, e.g., applied vibration, until the beverage containers are aligned, after which the actuation may stop.

### Air Blast Station

Once the beverage containers are aligned in a uniform direction upon exit from the can positioning pads 110, the beverage containers proceed to the air blast station 115. The air blast station 115 may be optionally present and/or operational. For example, the air blast station 115 may be present and operational in situations where the beverage container may have condensation on its external surface. Alternatively, the air blast station 115 may not be present or may be bypassed where condensation is not present on the outside surface of the beverage container. In situations where the air blast station 115 may be optionally operational, the air blast station 115 may be configured with a moisture sensor to detect condensation on an external surface of a beverage container. If condensation is detected the air blast station 115 will be operational and if it is not detected it will not be operational and the beverage container will just pass through the station 115. Other mechanisms to check for condensation may be determining temperature of the beverage container at time of loading and external environment differential to determine likelihood of condensation presence.

The air blast station 115 may be a chamber within with high pressure air is applied to the beverage containers. The air blast station 115 may move air through pressure air jets and/or high velocity fans. The air jet blasts may be configured using, e.g., nozzles and/or directional pipes with compressed air machine to provide blast air flow or streamed air flow. The air jet blasts may be applied at a variety of distances, e.g., 2 to 4 inches. Further the air blast station 115 may have a clamp mechanism to secure the beverage container (e.g., along a rim around the top of the beverage container) to help present it move moving out of alignment as the air blasts are applied.

Unlike unfilled cans, pre-filled and sealed beverage containers collect condensation when exposed to an immediate temperature change of greater than, for example, 6 degrees Fahrenheit (F). This condensation, if left unattended, would prevent shrink sleeves from properly sliding down an entire length of the beverage container. Accordingly, the disclosed configuration leverages a system of air jet blasts, e.g., circular air jet blasts, to remove condensation from side wall of the beverage containers facing the air jet blasts. The beverage containers may be secured with the chamber to prevent movement of from its aligned position. The air jets may be situated 2-3 inches from the beverage container on either side of the conveyor. The air jets may be structured to move vertically from top to bottom or vice versa along the length of an exterior beverage container wall. In some embodiments, the air jets maybe configured to allow rotation around a circumference of the exterior wall of the beverage container. Byway of example, the air jet may begin by removing condensation from the top of the beverage container, slowly working down as the can passes lower, subsequent air jets. Despite the ongoing variance between beverage temperature and external air temperature, the air jets allow for 4-6 seconds of dry surface area on the beverage container for the sleeve to be properly applied.

### Sleeve Applicator

After the beverage container leaves the air blasts 115, it proceeds to the sleeve applicator station 120. The sleeve applicator is used to apply a label to the beverage container. The label is structured as a shrink wrap sleeve. In one embodiment, the sleeve application may have a plurality of sleeves pre-printed and on a roll. The roll may be loaded on a spindle and may be unwound and each sleeve is pulled from the roll and place around the beverage container. The sleeve may be cut before or after placement around the beverage container.

The sleeve may be structured as a cylindrical label once unwound from the roll and expanded outward. The sleeve cylinder may have a circumference slightly larger than the circumference of the beverage container. The sleeve may be approximately the same length as the surface of the exterior of the beverage container where the label will affix and with openings at both ends of the cylinder. In alternate embodiments, the sleeve may be a flat sheet that has a length that is tailored to the surface area of the exterior of the beverage container and a width that is tailored to the circumference of the beverage container. The flat sheet may form a sleeve when encircled about the circumference of the beverage container.

Each sleeve design may be batched with other “like designs” on a roll according to the specific beverage being fed through the system. For example, if one hundred different designs are to be applied to the same beverage type, they are organized onto the same or subsequent rolls. This allows for seamless transitions between different designs, allowing the production of many unique, “customized” stock keeping units (SKUs) of beverages at the speed traditionally achieved for a single SKU.

The sleeve applicator station 120 unwinds a roll of sleeves, widening each to properly slide onto a beverage container. Once the sleeve is extended downward to the desired length below a cutting zone of the station, the sleeve applicator 120 cuts each sleeve to separate it from the remainder of the roll. This system leverages a laser motion sensor to properly time the application of a sleeve as a beverage can passes underneath the applicator. Moreover, as the alignment position of the can is maintained since exiting the can positioning pads 110, the sleeve of each beverage container beverage container is uniformly positioned relative to the tab at the top of the beverage container.

### Sleeve Pull-Downs

With the sleeve positioned over the beverage container by the sleeve applicator 120, the beverage container moves to the sleeve pull down station 125. The sleeve pulldown station 125 may be optional depending on how precisely the sleeve applicator can align the sleeve relative to the beverage container. These sleeve pull-down station 125 ensures the sleeves are flush with the bottom of the beverage container. The sleeve pull-down station 125 may be configured of rubber clamps or grips to pull down any sleeves that have not slid down to the bottom of the beverage container on their own.

In one example embodiment, the shrink sleeves are pre-cut prior to the sleeve pull downs. Hence, a precut sleeves may be individually pulled over a corresponding beverage container. In another example embodiment, the sleeve pull-down may pull down from the roll a sleeve that is open on top and bottom to pull down over the can starting from the top of the beverage container and moving towards the bottom of the beverage container. A cutting instrument may thereafter cut a top part of the sleeve and bottom part of the sleeve once the sleeve is appropriately positioned around the beverage container.

### Steam Tunnel

From the sleeve pull-down station 125 (or directly from the sleeve applicator station 120 if no separate pull down station 125), the sleeve is appropriately positioned on a pre-filled and sealed beverage container. The sleeved beverage container is sent through the steam tunnel 130. The steam tunnel is a chamber that uses steam to shrink the sleeve to a tight fit over the exterior wall of the beverage container. Traditionally a shrink sleeve is tightened to a beverage container through the use of convective or radiant heat. When the beverage container is filled with a beverage, the radiant heat could alter the characteristics of the beverage inside. Hence, to avoid this problem the disclosed configuration uses a steam configuration that generates just enough heat for the necessary tightening of the shrink wrap sleeve over the exterior of the beverage container, but does not materially alter (or nominal effect on) the characteristics of the beverage inside the beverage container. The steam and its high heat energy transfer allows for a strong shrink while maintaining relatively low actual air temperatures within the chamber of the steam tunnel 130.

Within the steam tunnel 130, in one embodiment it may include multi-port nozzles to emit steam on both sides of the beverage container to ensure a uniform shrink across the top, middle, and bottom of all four sides of the beverage container. The system may be set so that there is a strong flow of steam entering the chamber (90% of capacity) and the exhaust flume is largely closed (75% closed). Both settings contribute to higher steam density in the steam chamber 130, allowing for a more impactful reaction on the shrink sleeve without overly increasing the air temperature itself. The beverage containers may be moved through the chamber relatively quickly, for example, a predefined minimum time for exposure (e.g., at 3 seconds of exposure). This allows for a strong and rapid reaction on the shrink sleeve, while lessening the already minimal impact (due to the use of steam rather than convective or radiant heat) on the beverage contained within the beverage container.

### Example Manufacturing Process

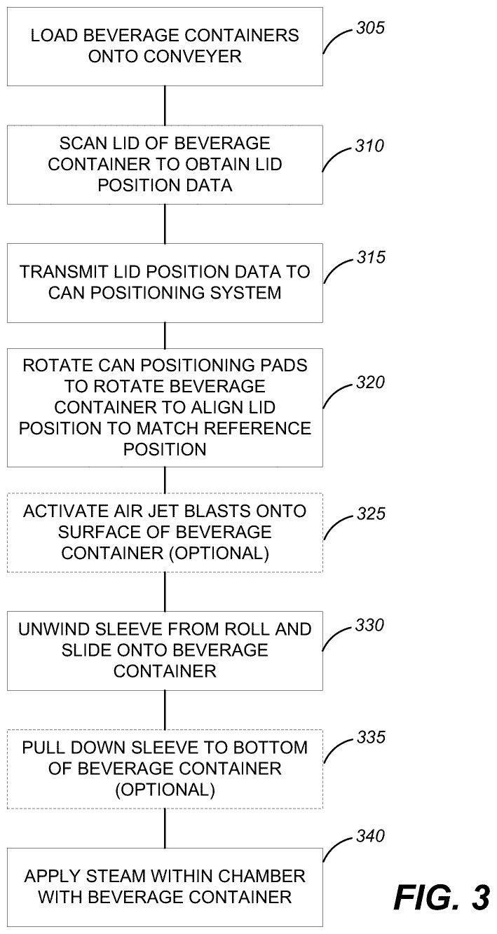

FIG. 3 illustrates an example manufacturing process for uniform application of labels to a pre-filled and pre-sealed beverage container. The process starts by loading 305 one or more beverage containers onto a conveyer, or other receiving system, or the containers. The conveyer may have a track to keep the cans from having limited movement laterally while moving in a forward (or reserve) direction. As previously noted the containers may be a filled and sealed aluminum cans filled with a beverage. In one embodiment the beverage containers are loaded upright with a beverage container top facing upward.

The process continues with the lid reader 105 scanning 310 the top of the beverage container to obtain lid position data, for example, a location of the can tab opening relative to a predefined reference point. The lid reader 105 transmits 315 the position data to the can positioning system 110. The can positioning system 110 uses the received position data to rotated the can received from the lid reader 105 station. Specifically, the can positioning system 110 rotates 320 the can positioning pads (or other actuated movement of the pads) so that the beverage container is rotated to align its top to match a reference position.

The beverage container moves to the air blast station 115, if present. The air blast station 115 activates 325 air blasts onto the surface of the beverage container. As noted above activation may be based upon detection of moisture (e.g., condensation) on an exterior of the beverage container. In configurations where the optional air blast station 115 is present there is no moisture detected on an exterior of the beverage container, the beverage container may pass through the station without the air blasts activating.

When the air blast station 115 is activated, e.g., by detection or moisture or a generally active configuration, the air blasts are released (e.g., from nozzles or other opening) to remove particles and condensation from the surface of the beverage container. The beverage container moves to the sleeve applicator station 120 where a labeling sleeve is unwound 330 from a roll and slid onto the outer surface of the beverage container. The pull-down sleeve station 125 is next and optional. If applicable, it pulls 335 the sleeve down to the bottom of the beverage container.

With the sleeve positioning around the circumference of the beverage container and label positioned relative to a reference position at the top of the beverage container, the beverage container enters the steam tunnel 130. The steam tunnel may include a chamber with steam vents. The vents release steam to apply 340 steam within the chamber to raise the temperature of the chamber within a predefined range to shrink wrap the sleeve label onto the beverage container. The steam tunnel operates at a temperature that does not materially affect the contents within the sealed beverage container. By way of example the predefined temperature range in a chamber of the steam tunnel may be between 70 and 90 degrees Celsius and can be varied as needed, for example, between 71 and 88 degrees Celsius. The beverage container may be within the chamber for a period of, for example, 2 to 5 seconds while the steam is applied to raise the temperature in the chamber to the temperature necessary for shrink wrapping the label onto the beverage container. The process is configured to have nominal effect on the internal beverage temperature. For example, the heat within the chamber may cause the beverage content to fluctuate in temperature by a nominal range, e.g., 0 to 1.5 degrees Celsius. The configuration can manage this fluctuation by managing the temperature of the chamber and the beverage container's time within the chamber as needed. From the steam tunnel 130 the beverage container is ready for packaging after a predetermined time period after which the shrink wrap label is considered affixed.

### Example Processing Machine/System

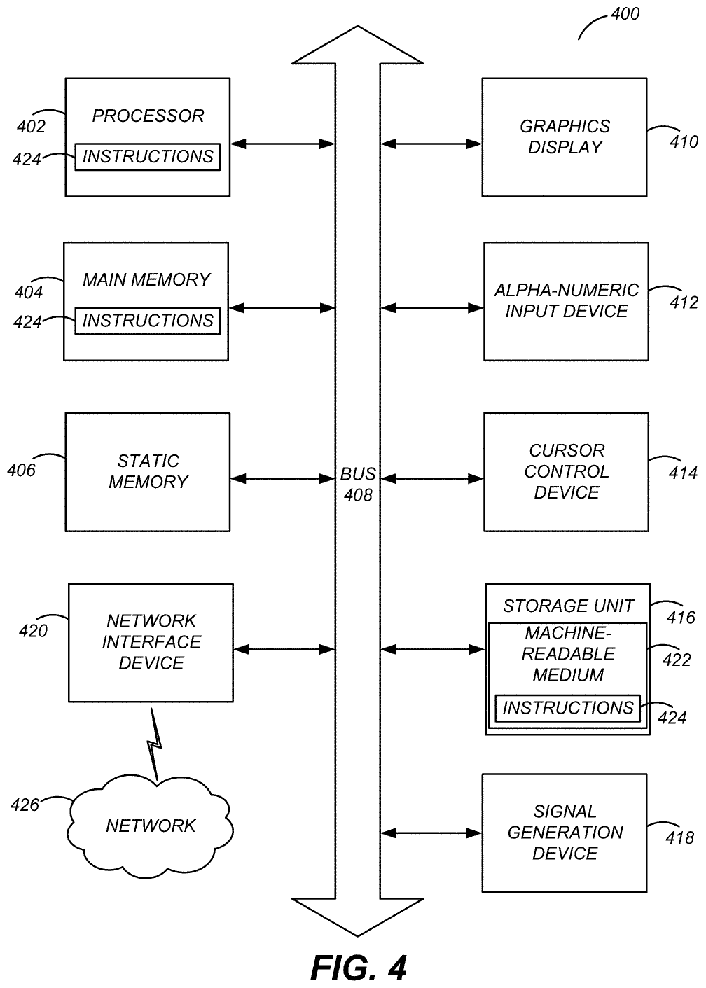

FIG. 4. illustrates example components of processing machine that may be used to operate the control systems for the manufacturing process. This portions or all of the components of these machines may be used with a control system. The control system may be configured to interoperate with components of some or all of the stations described with FIG. 1. This may allow for control over the speed a which beverage containers move through the system 100 as well as activity at individual stations. For example, if the sleeve applicator station 120 needs a refill of the sleeve roll it may notify the computing system, that in turn may temporarily stop the system 100 until the sleeve roll is changes. The control system also may be configured to do activity such as upload and/or provide a reference frame and/or position for the beverage container. The control system also may monitor quality of outputs from each station and take remedial action as needed.

With the above in mind, FIG. 4 is a block diagram illustrating components of an example processing machine able to read instructions from a machine-readable medium (e.g., a data store such as a memory or disk) and execute them in a processor (or controller). Specifically, FIG. 4 shows a diagrammatic representation of a machine in the example form of a computer system 400, which may be the control system, within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the control system 400 may operate in the capacity of a server machine or a client machine in a server-client network environment, or as a peer machine in a peer-to-peer (or distributed) network environment.

The computer system 400 may be a server computer, a client computer, a personal computer (PC), a tablet PC, a smartphone, a web or other network based hardware appliance, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein. For example, the instructions may be to control operation of each station and activity between them as described with FIGS. 1-3.

The example computer system 400 may include a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Example Output and Additional Considerations

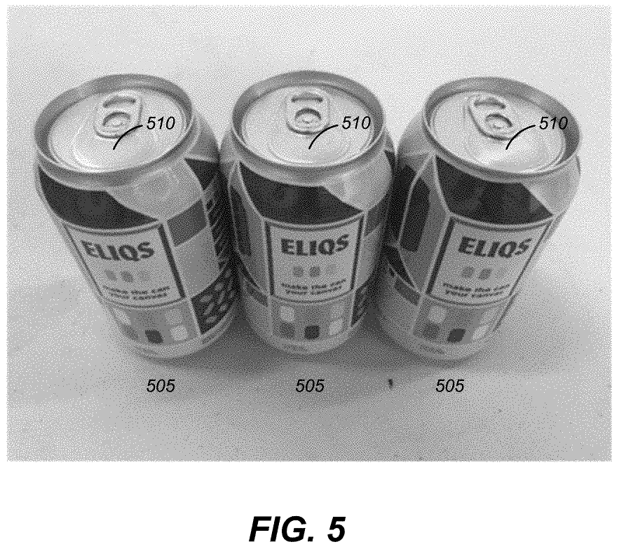

FIG. 5 illustrates an example output from a manufacturing production system that applies a customized label onto beverage containers. The image illustrates the output of the disclosed system and process providing uniformity of label orientation on a beverage container, e.g., an aluminum can for beverages such as sodas, beer and wine.

Existing processes for beverage container labeling create randomized label location with respect a top part (e.g., lid) of a beverage container. For example, when you purchase a 6-pack or a 24-pack of beverage container that use existing labeling processes, each beverage container in the pack will have a different label location compared to the top tab opening area, which is completely random. In existing processes, because the beverage container labeling happens prior to the filling of the beverage in the beverage container and the capping of the labeled, canned beverage, the beverage container has no definitive “Front” or “Back”. In these existing processes for labeling, the capping of the labeled, filled beverage can is what defines the “Front” and “Back”, and this capping process, e.g., sealing the beverage container with the beverage (content) filled may be done randomly.

The contents within the beverage container may introduce challenges of labeling after fill and seal such as those previously described including, for example, condensation on external of the beverage container that may prevent precision in affixing the label to the container and/or altering the contents within the beverage container itself if heat is applied to the beverage container. The disclosed configuration and/or process as described addresses these challenges and provides for opportunities such as precision customized labeling of prefilled and sealed beverage containers. This may include not only customized labeling, but affixing the labeling in a uniform manner relative to each container physical structure (e.g., beverage container opening). The disclosed innovation allows for designs to be applied with a standardized, non-random label location with respect to the beverage container top. The design on the beverage container with respect to the cap is chosen and defined so that it may be located in the same place as other beverage containers of the same design and structure, for example, within a same processed batch and/or subsequent batches. In addition, the label application may define a “Front” and a “Back” of the beverage container. This may be used in addition to, or in lieu of, the beverage container tab opening (or cap). When opening a beverage container that was labeled using the disclosed configuration, there may be a uniform “Front” and a uniform “Back” to every beverage container. This uniform “Front” and “Back” of the beverage container are non-random and identical across every beverage container of the same label design in the same and/or subsequent batch run through the disclosed configuration.

Additionally, unlike pressure labels which are visibly obvious as stickers adhered to the outside of the beverage container, the vehicle of customization disclosed herein (e.g., shrink sleeves) provides for a unitary experience between the label and beverage container. For example, the disclosed configuration provides for application of a label that shrink fits to the beverage container and provides an experience in which the label appears to be imprinted on the beverage container.

Further, the configuration allows for a process that allows for small batch size customization of one or more beverage containers in a fast and economical manner. For example, the disclosed system allows for micro-batch customization with no lead time. Existing processes for beverage container are cumbersome. First, the labels are pre-printing at a print shop prior to the beverage container being filled. In the art of can labeling, the first part of this process is completed at a printing shop and the latter part of this process is completed at a label application facility prior to the beverage containers being shipped to a beverage manufacturer. Thereafter, the beverage manufacturer fills the beverage, the top is applied thereafter in a random manner (e.g., just dropped onto the open top and sealed without regard for positioning).

The typical lead time that is quoted by beverage manufacturers is over 12 weeks, and the minimum may be 8 weeks. In contrast to conventional approaches, the disclosed configuration changes ordering so that the label application occurs after the can is filled and capped. This allows for a lead time of only 1-2 days: 1 day to create the design, print it, and apply it to the filled can.

The principles described herein can be applied to other canning processes that may include foodstuffs already filled and sealed like the beverage container. For example, in these embodiments, the beverage container may be a juice can, a fruit or vegetable filled can, or other foodstuff can.

While the disclosed configurations have been described in the context of individual stations, it is noted that in some configurations of the system 100, one or more station structures and/or functions may be combined within a single physical station. For example, the lid reader 105 and can-positioning pads may be within a single station. In another example, the air blasts 115, sleeve applicator, and sleeve pull downs may be within a single station.

It is noted that unless specifically stated otherwise, discussions herein using words such as “processing,” “computing,” “determining,” ““displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a custom label manufacturing for filled and sealed beverage containers through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system for labeling a beverage container, the system comprising:
a conveyer structured to receive and transport the beverage container along the system, the beverage container prefilled with an ingestible content and sealed with content, a top of each beverage container having a mark,
a lid reader, aligned with the conveyer, to determine a location of the mark relative to an alignment point, the lid reader configured to generate an alignment signal;
a can positioning pads positioned along the conveyer after the lid reader to receive the beverage container and to receive the alignment signal at a control system to actuate the can positioning pads to move the beverage container rotationally until the mark aligns with a reference position;
a sleeve applicator positioned along the conveyer to receive the beverage container and to and to unroll a pre-printed sleeve label from a roll to overlay the sleeve around an exterior of the beverage container; and
a steam tunnel positioned along the conveyer to receive the beverage container and to release steam once the beverage container is within, the steam causing the sleeve label to shrink onto the beverage container.

2. The system of claim 1, wherein an air blast station positioned along the conveyer after the can positioning pads to receive the beverage container and, in response to a presence of condensation on an exterior of the beverage container, to release high pressure air onto the exterior of the beverage container;

3. The system of claim 2, further comprising a sleeve pull down subsystem positioned along the conveyer and having clamp grips to pull a bottom of the overlaid sleeve label around the exterior of the beverage container substantially flush with a bottom of the beverage container.

4. The system of claim 2, wherein the beverage container is an aluminum can.

5. The system of claim 2, where the mark is a tab associated with a location for an opening.

6. The system of claim 1, wherein the can positioning pad comprises a roller with flexible surfaces.

7. The system of claim 1, wherein the can positioning pad comprising a vibration damper.

8. The system of claim 1, where the can positioning pad control system applies the received adjustment signal to adjust a speed of the can positioning pad to rotate the beverage container at a plurality of rates of movement.

9. The system of claim 2, wherein the air blast station comprises at least one of one or more nozzles and directional pipes to apply air jet blasts in a circular motion.

10. The system of claim 2, wherein the air blast comprises a nozzle structured to be in a range of 2 to 4 inches from a beverage container.

11. The system of claim 10, wherein the air blast station comprises a clamp mechanism to couple a rim of a top of a beverage container.

12. The system of claim 4, wherein the steam tunnel applies steam within a chamber to place the chamber within a temperate range of 70 to 90 degrees Celsius.

13. The system of claim 4, wherein the steam tunnel applies heat as the beverage can moves through along the conveyer.

14. The system of claim 13, wherein the steam tunnel applies radiant heat.

15. The system of claim 13, wherein the steam tunnel applies heat for at least 2 seconds.

16. The system of claim 3, wherein the air blast station includes a moisture sensor.

17. A system for labeling a beverage container, the system comprising:
a conveyer structured to receive and transport the beverage container along the system, the beverage container prefilled with an ingestible content and sealed with content, a top of each beverage container having a mark,
a lid reader, aligned with the conveyer, to determine a location of the mark relative to an alignment point, the lid reader configured to generate an alignment signal;
a can positioning pads positioned along the conveyer after the lid reader to receive the beverage container and to receive the alignment signal at a control system to actuate the can positioning pads to move the beverage container rotationally until the mark aligns with a reference position;
an air blast station positioned along the conveyer after the can positioning pads to receive the beverage container and having a moisture, in response to detection of moisture on an exterior of the beverage container by the moisture sensor releasing high pressure air onto the exterior of the beverage container and in response to no detection of moisture on the exterior of the beverage container passing the beverage container through without release of high pressure air onto the exterior of the beverage container;
a sleeve applicator positioned along the conveyer to receive the beverage container and to and to unroll a pre-printed sleeve label from a roll to overlay the sleeve around an exterior of the beverage container; and
a steam tunnel positioned along the conveyer to receive the beverage container and having a chamber, the steam tunnel releasing steam once the beverage container is within the chamber to cause the sleeve label to shrink onto the beverage container.

18. The system of claim 17, wherein the beverage container is an aluminum can.

19. The system of claim 18, wherein the steam tunnel applies steam within the chamber within a temperate range of 70 to 90 degrees Celsius.

20. The system of claim 19, wherein the steam is applied for a period of between 2 to 5 seconds.
